(19) United States
(12) Patent Application Publication
(10) Pub. No.: US 2016/0245183 A1
(43) Pub. Date: Aug. 25, 2016

(54) ACCESSORY GEARBOX FOR TURBOMACHINE

(71) Applicant: HISPANO SUIZA, Colombes (FR)

(72) Inventors: Julien VIEL, Argenteuil (FR); Stéphane PRUNERA-USACH, Jurançon (FR)

(21) Appl. No.: 15/027,850

(22) PCT Filed: Oct. 7, 2014
(86) PCT No.: PCT/FR2014/052541

§ 371 Date: Apr. 7, 2016

(30) Foreign Application Priority Data
Oct. 11, 2013 (FR) 1359910

(51) Int. Cl. F02C 7/32

(52) U.S. Cl. CPC F02C 7/32; F05D 2260/4031

(57) ABSTRACT

A gearbox for the driving of auxiliaries for an aircraft turbomachine and which includes a first bevel pinion and a first bevel gear wheel forming an angle gear, the first bevel gear wheel being connected to a main shaft secured to one or more bevel pinions capable of driving one or more auxiliaries in rotation via one or more bevel gear wheels.

### TECHNICAL FIELD

The present invention relates to an accessory gearbox for a turbomachine, also called an “AGB”. Such an accessory gearbox is intended to transmit the original motion of the turbomachine through a radial shaft emerging from it, and to transmit it to various accessories or items of equipment attached to the turbomachine, such as pumps, electrical generators, etc., which are essential for the operation of the turbomachine or of other devices of an aircraft propelled by this turbomachine.

### STATE OF THE PRIOR ART

Document EP 2 405 116 represents an accessory gearbox of the prior art. Such an accessory gearbox generally has a casing which contains gears connected to one another in series forming a drive train. Each gear is then connected to a drive shaft, which itself imparts rotary motion to an accessory. The input shaft thus imparts rotary motion to a first gear, which is itself connected to one or more secondary gears, in order to impart rotary motion to them, where each secondary gear is itself connected to one or more tertiary gears, in order to impart rotary motion to them, and so forth. In the accessory gearboxes of the prior art, therefore, the gears are arranged in a cascade configuration, such that the first gear is used not only to impart rotary motion to a first accessory, but also such that it also enables the rotary motion to be transmitted to the secondary and tertiary gears, and so forth. However, such an accessory gearbox is very bulky as the gears are positioned adjacent to one another.

To remedy this problem document FR 2 981 986 describes an accessory gearbox which enables space savings to be made. However, in such a gearbox the gears are always connected in series with one another, such that if one of the gears is defective it can cause a malfunction of the entire drive train. The first gear also bears all the torque impetus of the entire drive train, which generally means that it must be made larger than its inherent requirement demands. Indeed, in such a gearbox the upstream gears are impacted by the power transmitted to the downstream gears, such that it is difficult to optimise the dimensioning of each gear independently of the other gears.

### DESCRIPTION OF THE INVENTION

The invention seeks to remedy the disadvantages of the state of the art by proposing an accessory gearbox architecture which enables space savings to be made for the installation in the turbomachine, and in which its drive train is optimised with regard to the power characteristics of the accessories of the turbomachine and of the aircraft, compared to those of the prior art.

To accomplish this, a first aspect of the invention proposes an accessory gearbox for an aircraft turbomachine containing a first conical gear and a first conical toothed wheel forming an angle transmission, where the first conical toothed wheel is connected to a main shaft coupled with one or more conical gears able to impart rotary motion to one or more accessories by means of one or more conical toothed wheels.

Thus, according to the invention, the motion of the input shaft is no longer transmitted directly to the gears, but is transmitted to the conical toothed wheels of the accessories by means of a main shaft with conical gears. These conical gears do not allow rotary motion to be imparted directly to the accessories, but they enable rotary motion to be imparted to the conical toothed wheels, which themselves impart rotary motion to the accessories. The toothed wheels can therefore be dimensioned solely with regard to the power which they transmit to the accessories, and no longer depending on the other toothed wheels. The gears are also no longer connected to one another, which increases the overall reliability of the gearbox. In addition, the presence of the main shaft creates a space saving, since the conical toothed wheels can be positioned circumferentially around the main shaft.

The gearbox according to the invention may also have one or more of the characteristics below, considered individually, or in all possible technical combinations.
the main shaft extends along a reference axis,
the main shaft has a distal end,
the distal end of the main shaft is connected to at least one distal accessory;
the distal accessory extends along a distal drive axis,
the distal drive axis of the distal accessory is aligned with the reference axis of the main shaft;
the main shaft includes a spur pinion meshing with a gear of an additional accessory extending along a drive axis, where the said drive axis is parallel to the reference axis of the main shaft;
each conical gear surrounds the main shaft;
the gearbox includes at least two conical gears, both conical gears being able to impart rotary motion to one or more accessories by means of one or more conical toothed wheels, where both conical gears are positioned in succession around the main shaft.

A second aspect of the invention also relates to a turbomachine including an accessory gearbox according to the first aspect of the invention.

Advantageously, the turbomachine also has a primary flow path in which a primary airstream flows, which is generally high-pressure, and a secondary flow path in which a secondary airstream flows, which is generally low-pressure. The gearbox is preferably located between the primary flow path and the secondary flow path, but it can also be located in the area of the fan, for example around the secondary flow path or in the turbine area, for example around the primary flow path, or also in the core area.

Thus, according to a first embodiment the turbine has a fan area, and the accessory gearbox is located in the fan area. The fan area is an area located close to the fan.

According to another, second embodiment the turbine has a turbine area, and the accessory gearbox is located in the turbine area.

According to a third embodiment the turbine has a core area, and the accessory gearbox is located in the core area.

### BRIEF DESCRIPTION OF THE FIGURES

Other characteristics and advantages of the invention will be seen clearly on reading the detailed description below, with reference to the appended figures, which illustrate:

FIG. 1, a perspective view of an accessory gearbox according to one embodiment of the invention;

FIG. 2, a top view of the accessory gearbox of FIG. 1;

FIG. 3, a perspective view of an accessory gearbox according to another embodiment of the invention;

FIG. 4, a front view of a portion of a turbomachine according to one embodiment of the invention;

FIG. 5, a perspective view of the portion of a turbomachine of FIG. 4.

For greater clarity, identical or similar elements are identified by identical reference signs in all the figures.

### DETAILED DESCRIPTION OF AT LEAST ONE EMBODIMENT

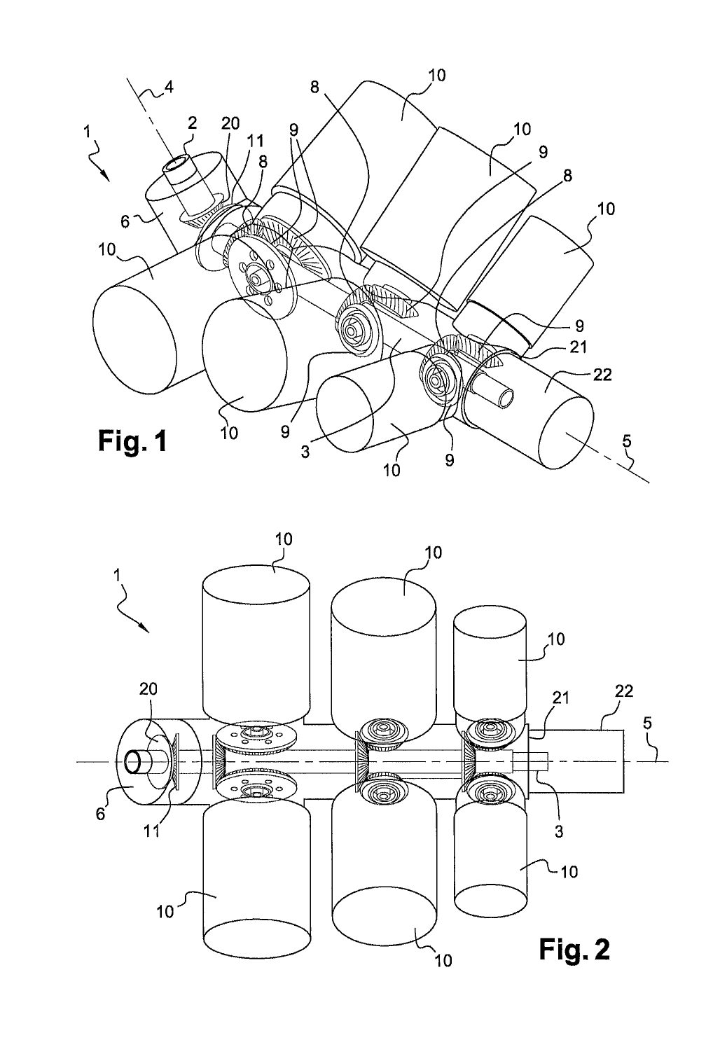

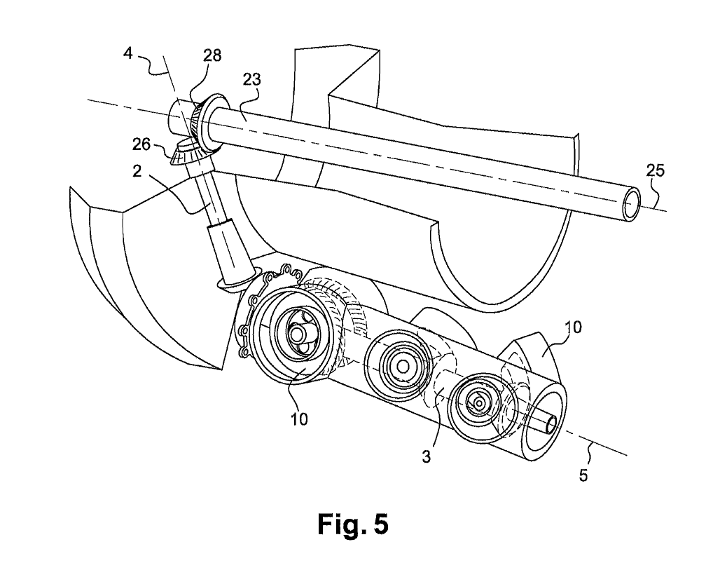

FIGS. 1 and 2 represent an accessory gearbox 1 according to the preferred embodiment of the invention. FIGS. 4 and 5 represent this gearbox incorporated in the core area of a turbomachine. This gearbox 1 includes an input shaft 2 which is connected to a drive shaft 23 of a turbomachine such that it is imparted with rotary motion when drive shaft 23 is rotating. To this end input shaft 2 is coupled with a gear 26, while drive shaft 23 is coupled with a gear 28. Gear 26 coupled with the input shaft meshes with gear 28 coupled with drive shaft 23. Gears 26 and 28 are preferably conical, such that they form an angle transmission between the direction in which the drive shaft extends and the direction in which the input shaft extends.

Drive shaft 23 can, in particular, be a shaft from the high-pressure body of a turbomachine. Drive shaft 23 extends along an axis called the “drive axis”. Input shaft 2 extends along a first reference axis, called an “input axis” 4 in what follows. Input axis 4 extends in a direction secant to the direction in which drive axis 25 extends.

Gearbox 1 includes accessories 10. These accessories can, for example, be a fuel pump, a lubrication unit or an electrical machine. It enables the motion of input shaft 2 to be imparted to accessories 10.

To this end, gearbox 1 has a main shaft 3 which extends in a reference axis 5. In this document the terms “axial” or “longitudinal” are used with reference to this reference axis 5.

Main shaft 3 is connected to input shaft 2 by a transfer gearbox 6, also called a TGB. This transfer gearbox 6 enables an angle transmission to be made between input axis 4 and reference axis 5 of the main shaft, and by this means enables the rotary motion of the drive shaft to be imparted to the main shaft. This angle transmission is made by means of a first conical gear and a first conical toothed wheel 11. The first conical gear and the first conical toothed wheel 11 enable the desired angle between input axis 4 and reference axis 5 to be adjusted. In a preferred embodiment, first conical toothed wheel 11 is joined to main shaft 3.

Advantageously, a first angle transmission is made between drive shaft 23 and input shaft 2, and a second angle transmission is made between input shaft 2 and main shaft 3. Main shaft 3 therefore extends roughly parallel to drive shaft 23.

Accessory gearbox 1 also has conical gears 8 coupled to main shaft 3. The rotary motion is transmitted to the accessories through conical toothed wheels 9, connected to accessories 10, meshing with conical gears 8. In a preferred embodiment conical gears 8 are positioned around main shaft 3. Conical gears 8 are positioned in succession, in the longitudinal direction.

Advantageously, at least one conical gear 8 enables rotary motion to be imparted to two accessories simultaneously. To accomplish this the said conical gear meshes simultaneously with two toothed wheels 9.

Each conical gear 8 therefore enables rotary motion to be imparted to one or more accessories 10 simultaneously. The angle formed by accessories 10 meshing with a single conical gear 8 can be chosen according to the space available for the gearbox. Each accessory 10 extends in a direction secant to reference axis 5. Accessories 10 thus form branches which radiate around main shaft 3.

Gearbox 1 can thus contain one or more groups of accessories extending radially relative to the reference axis, where these groups are distributed in the longitudinal direction. In a particular embodiment main shaft 3 can have only a single conical gear 8 and only a single group of accessories.

In a particular design at least one end 21 of main shaft can be fitted with an accessory called a “distal accessory” 22 the drive axis of which, called the “distal drive axis”, is colinear with reference axis 5.

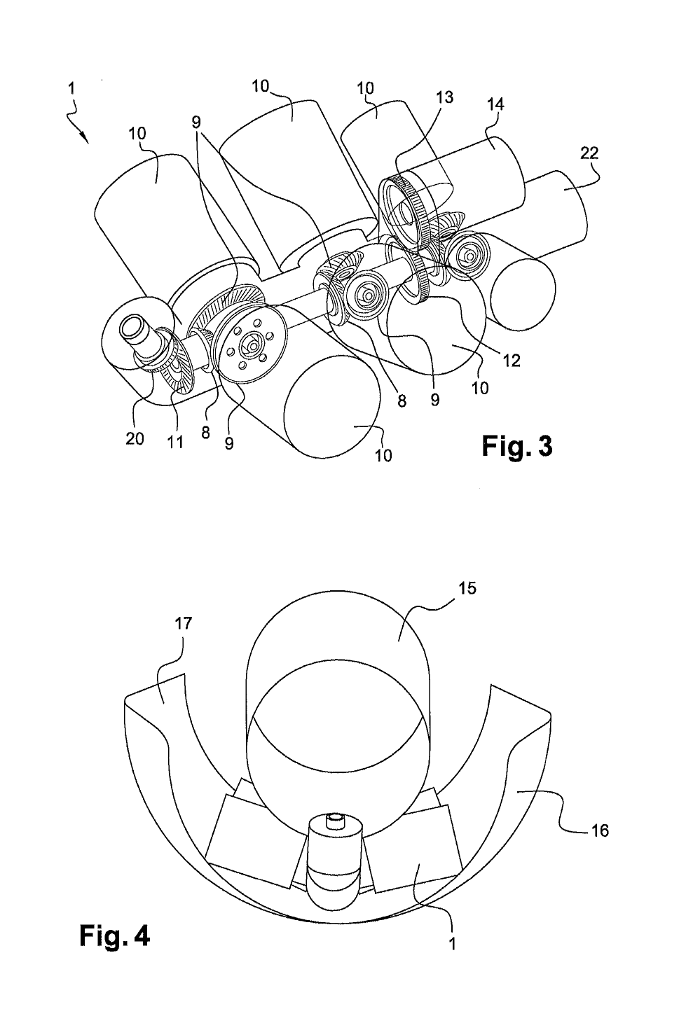

FIG. 3 represents another embodiment in which main shaft 3 has a spur pinion 12, enabling rotary motion to be imparted to an additional accessory 14, through a spur pinion 13 extending in a direction parallel to reference axis 5. In a particular design these gears 12, 13 with parallel axes can be helical.

Using a main shaft 3 with conical gears as an intermediate element to transmit the motion of the input shaft to the conical toothed wheels coupled with the accessories thus allows more possibilities for the architecture of the gearbox. Indeed, the presence of the main shaft enables the shape of the gearbox to be designed to fit the space available for the gearbox in the turbomachine.

FIG. 4 represents a portion of a turbomachine with a wall of generally circular shape 15 and a wall of generally rotationally symmetrical shape 16. Wall 15 demarcates a primary flow path in which the primary airstream of the turbomachine flows, generally the high-pressure airstream. Wall 16 demarcates the secondary flow path in which the secondary airstream of the turbomachine flows, generally the low-pressure airstream. Wall 16 surrounds wall 15 such that space 17 is defined between these two walls. The angle between accessories 10 and the geometry of gears 8 and 9 are chosen such that the gearbox enters into this space 17.

The invention is of course not limited to the embodiments described with reference to the figures, and variants could be envisaged without going beyond the scope of the invention.

1. A turbomachine comprising:
a drive shaft;
a gearbox of accessories for an aircraft turbomachine including:
an input shaft connected to the drive shaft by gears such that rotary motion is imparted to the input shaft when rotary motion is imparted to the drive shaft, wherein the input shaft extends in a direction secant to that of the drive shaft;
a first conical gear connected to the input shaft, and
a first conical toothed wheel forming an angle transmission with the first conical gear, wherein the first conical toothed wheel is connected to a main shaft coupled with one or more conical gears configured to impart rotary motion to one or more accessories by means of one or more conical toothed wheels, wherein the main shaft extends in a direction parallel to that of the drive shaft, and wherein the accessories extend in a direction secant to the direction in which the main shaft extends.

2. The turbomachine according to claim 1, wherein the main shaft extends in a reference axis, wherein the main shaft includes a distal end, wherein the distal end of the main shaft is connected to at least one distal accessory extending in a distal drive axis, and wherein the distal drive axis of the distal accessory is aligned with the reference axis of the main shaft.

3. The turbomachine according to claim 1, wherein the main shaft extends in a reference axis, wherein the main shaft includes a spur pinion meshing with a gear of an additional accessory, extending in a drive axis, and wherein the drive axis is parallel to the reference axis of the main shaft.

4. The turbomachine according to claim 1, wherein each conical gear surrounds the main shaft.

5. The turbomachine according to claim 1, comprising at least two conical gears, wherein the at least two conical gears are configured to impart rotary motion to one or more accessories by means of one or more conical toothed wheels, and wherein the at least two conical gears are positioned in succession around the main shaft.

6. The turbomachine according to claim 5, further comprising a primary air flow path, and a secondary airflow path, wherein the gearbox is located between the primary flow path and the secondary flow path.

7. The turbomachine according to claim 4, further comprising a fan area, wherein the gearbox of accessories is located in the fan area.

8. The turbomachine according to claim 4, further comprising a turbine area, wherein the gearbox of accessories is located in the turbine area.

9. The turbomachine according to claim 4, further comprising a core area, wherein the gearbox of accessories is located in the core area.
